(19) United States
(12) Patent Application Publication
(10) Pub. No.: US 2025/0050865 A1
(43) Pub. Date: Feb. 13, 2025

(54) CONTROL SYSTEM FOR A VEHICLE

(71) Applicant: Volvo Truck Corporation, Göteborg (SE)

(72) Inventors: Leo LAINE, Härryda (SE); Kristoffer TAGESSON, Hammarö (SE); Mikael ASKERDAL, Åsa (SE)

(21) Appl. No.: 18/720,745

(22) PCT Filed: Feb. 25, 2022
(86) PCT No.: PCT/EP2022/054889

§ 371 Date: Jun. 17, 2024

(30) Foreign Application Priority Data
Dec. 20, 2021 (WO) PCT/EP2021/086758

(51) Int. Cl. B60W 30/02

(52) U.S. Cl. CPC B60W 30/02; B60W 2555/20

(57) ABSTRACT

A control system for a vehicle. The control system comprises a force determination controller adapted to determine external load characteristics of external loads that currently act or are predicted to act on the vehicle. The control system is adapted to determine a resulting force vector to be acting on the vehicle, using the external load characteristics, in order to obtain a requested vehicle operation behaviour. The control system is further adapted to issue control information to one or more motion support devices of the vehicle in order to control the one or more motion support devices so as to generate the resulting force vector on the vehicle. The control system further comprises a feedforward controller adapted to receive wind information representative of a wind currently acting or predicted to be acting on the vehicle.

### TECHNICAL FIELD

The invention relates to a control system for a vehicle. Moreover, the present invention relates to a vehicle. Further, the present invention relates to a method for controlling a vehicle.

The invention can be applied in heavy-duty vehicles, such as trucks, buses and construction equipment. Although the invention will be described with respect to a truck, the invention is not restricted to this particular vehicle, but may also be used in other vehicles such as articulated haulers and backhoe loaders.

### BACKGROUND

A vehicle, for instance a truck, may be subjected to wind loads during operation. Such wind loads may have an influence on the operation of the vehicle.

To this end, according to its abstract, US 2018/0162400 A1 discloses that one or more devices, systems, and/or methods for controlling a motor vehicle based upon wind are provided. For example, a first measurement of wind detected by a first sensor coupled to the motor vehicle may be received from the first sensor. A second measurement of wind associated with a location of the motor vehicle may be received from a server. The wind effect (e.g., cost, inefficiency, danger, etc.) on the motor vehicle may be determined based upon the first measurement of wind and/or the second measurement of wind. A corrective action for the motor vehicle may be determined based upon the wind effect, and may be implemented on the motor vehicle.

Although the US 2018/0162400 A1 method or device may be used for controlling a vehicle whilst taking wind loads into account, there is still a need for further development within the technical field of vehicle control in response to wind induced loads.

### SUMMARY

An object according to a first aspect of the present invention is to provide a control system by which it is possible to establish information that can be used for determining wind loads with an appropriate level of accuracy.

According to a first aspect of the invention, the object is achieved by a control system according to claim 1.

As such, a first object of the present invention relates to a control system for a vehicle. The control system comprises a force determination controller adapted to determine external load characteristics of external loads that currently act or are predicted to act on the vehicle. The control system is adapted to determine a resulting force vector to be acting on the vehicle, using the external load characteristics, in order to obtain a requested vehicle operation behaviour. The control system is further adapted to issue control information to one or more motion support devices of the vehicle in order to control the one or more motion support devices so as to generate the resulting force vector on the vehicle.

According to the first aspect of the present invention, the control system comprises a feedforward controller adapted to receive wind information representative of a wind currently acting or predicted to be acting on the vehicle. The feedforward controller is in communication with the force determination controller whereby the force determination controller is adapted to use wind load information, indicative of the wind load imparted on the vehicle and determined on the basis of the wind information, for determining at least a portion of the external load characteristics.

As used herein, the term “feedforward controller” encompasses an element or component within a control system that passes a controlling signal from a source in its external environment to a load elsewhere in its external environment.

The control system according to the first aspect of the present invention implies that information relating to the wind currently acting or predicted to be acting on a vehicle is used in an appropriately accurate manner when determining at least a portion of the external load characteristics. The above in turn implies that the external load characteristics may be determined with an appropriate level of accuracy which in turn may imply an appropriate control of the vehicle.

Purely by way of example, the control system according to the first aspect implies that the control system can be used for obtaining the requested vehicle operation behaviour, for instance related to a certain requested speed and/or acceleration, even when the wind acting on the vehicle changes rapidly due to e.g. wind gusts. As such, the control system according to the present invention implies an operation of the vehicle which may follow the requested vehicle operation behaviour in an appropriate manner even when the wind ambient of the vehicle is dynamic, e.g. fluctuating in speed and/or heading.

Optionally, the wind information is indicative of a wind speed, relative to the vehicle, of a wind currently acting on the vehicle.

Optionally, the wind information is indicative of a wind heading, relative to the vehicle, of a wind currently acting on the vehicle.

Optionally, the control system is adapted to use at least the following entities for determining the wind load information:
the wind information;
a drag coefficient, a side force coefficient, and/or a lift coefficient associated with the vehicle, and
a reference area associated with the vehicle.

Optionally, the feedforward controller is adapted to determine the wind load information.

Optionally, the wind load information comprises information relating to the magnitude and preferably also the direction of the wind load acting on the vehicle.

Optionally, the control system is adapted to receive operation request information indicative of the requested vehicle operation behaviour.

Optionally, the control system is adapted to determine the resulting force vector using the external load characteristics and the operation request information.

Optionally, the operation request information comprises information indicative of at least one of the following:
a requested acceleration of the vehicle;
a requested speed of the vehicle;
a requested rate of acceleration of the vehicle, and
a requested total force acting on the vehicle.

As used herein, the term “acceleration” is intended to encompass each one of a positive acceleration, indicating a speed increase rate, and a negative acceleration, indicating a speed decrease rate.

Optionally, the resulting force vector comprises a component extending in the intended direction of travel of the vehicle.

Optionally, the control system is adapted to use the operation request information and the wind information in order to determine a predicted future wind information.

The operation request information may be indicative of a future change of a state of the vehicle. For instance, the operation request information may be indicative of a future change in direction and/or a future change in speed of the vehicle. Such a future change in direction and/or speed may influence the wind that is expected to be acting on the vehicle in the future. As such, the use of the operation request information and the wind information in order to determine a predicted future wind information as indicated hereinabove implies that the future wind information may be predicted with an appropriate level of accuracy. This in turn implies that the control information issued to the to one or more motion support devices of the vehicle may result in a more appropriate, e.g. smoother, change of state of the vehicle since the predicted future load changes may be take into account in an appropriate manner. As another non-limiting example, the predicted future wind information may be used for determining a current capability of portions of the vehicle, such as a current capability of the one or more motion support devices.

Optionally, the control system is adapted to use the operation request information for determining at least a predicted future speed of the vehicle. The control system is adapted to use the predicted future speed of the vehicle, the wind speed and the wind heading for determining a predicted future wind speed and a predicted future wind heading.

A second aspect of the present invention relates to a vehicle comprising one or more motion support devices for creating a resulting force vector on the vehicle. The vehicle further comprises a control system according to the first aspect of the present invention.

Optionally, at least a first motion support device comprises an electric machine, preferably each one of a plurality of motion support devices comprises an electric machine.

Optionally, at least a second motion support device comprises a service brake, preferably each one of a plurality of motion support devices comprises a service brake.

Optionally, the vehicle comprises an operation request controller adapted to issue the operation request information to the control system, preferably the operation request controller is adapted to issue the operation request information to the control system in response to input received from an operator of the vehicle.

A third aspect of the present invention relates to a method for controlling a vehicle. The method comprises determining external load characteristics of external loads that are currently imparted or predicted to be imparted on the vehicle. The method comprises receiving wind information representative of a wind currently acting or predicted to be acting on the vehicle and using wind load information, indicative of the wind load imparted on the vehicle and determined on the basis of the wind information, for determining at least a portion of the external load characteristics. The method further comprises determining a resulting force vector to be imparted on the vehicle, using the external load characteristics, in order to obtain a requested vehicle operation behaviour. Further, the method comprises issuing control information to one or more motion support devices of the vehicle in order to control the one or more motion support devices so as to impart the resulting force vector on the vehicle.

Further advantages and advantageous features of the invention are disclosed in the following description and in the dependent claims.

### BRIEF DESCRIPTION OF THE DRAWINGS

With reference to the appended drawings, below follows a more detailed description of embodiments of the invention cited as examples.

In the drawings:

FIG. 1 is a side view of a vehicle according to an embodiment of the present invention;

FIG. 2 is a schematic top view of a vehicle;

FIG. 3 is a schematic view of a control system according to an embodiment of the present invention, and

FIG. 4 is a flowchart illustrating an embodiment of a method according to the present invention.

### DETAILED DESCRIPTION OF EXAMPLE EMBODIMENTS OF THE INVENTION

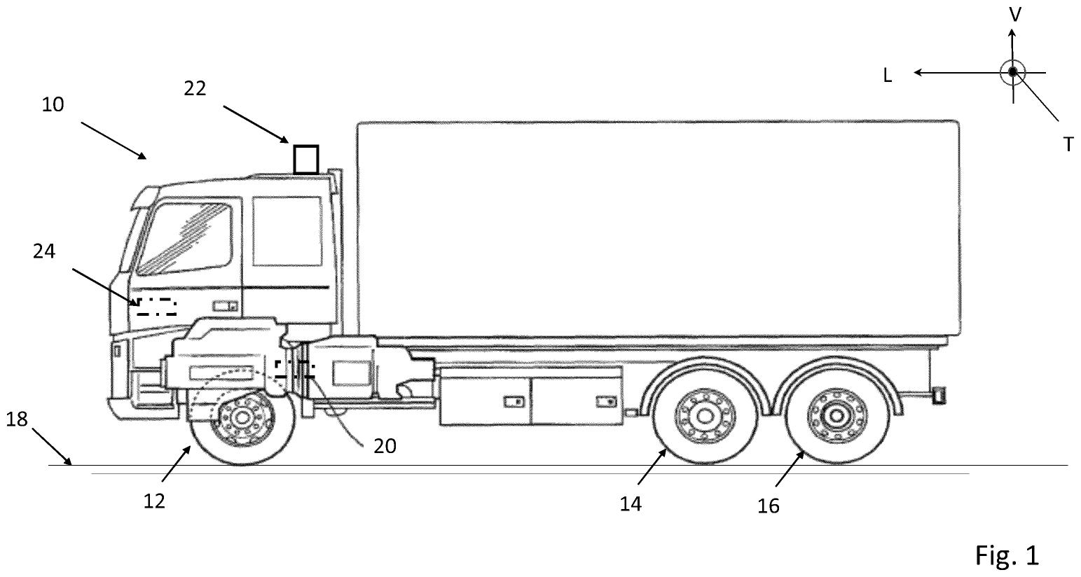

FIG. 1 is a side view of a vehicle 10 according to the present invention. In FIG. 1, the vehicle 10 is exemplified as a truck. However, it is also envisaged that the vehicle 10 according to the present invention may be another type of vehicle, such as a trailer (not shown) or a vehicle combination comprising a tractor and one or more trailers (not shown). As a general remark, applicable for all aspects and embodiments of the present invention, the vehicle 10 may be adapted to travel on ground.

As may be gleaned from FIG. 1, the vehicle 10 comprises a plurality of ground engaging members 12, 14, 16, each one of which being adapted to contact a ground surface 18 to thereby. In the FIG. 1 embodiment, the ground engaging members 12, 14, 16 are exemplified as wheels but it is also envisaged embodiments of the vehicle 10 may comprise one or more ground engaging members that are implemented in other ways. Purely by way of example, each one of one or more ground engaging members may be implemented as a crawler (not shown).

Moreover, as indicated in FIG. 1, the vehicle 10 has a longitudinal extension in a longitudinal direction L, a transversal extension in a transversal direction T and a vertical extension in a vertical direction V such that when the vehicle 10 is supported by a horizontally extending ground surface 18, the vertical direction V is parallel to a normal of the horizontally extending ground surface 18, the longitudinal direction L corresponds to an intended direction of travel of the vehicle 10 and the transversal direction T is perpendicular to each one of the longitudinal direction L and the vertical direction V.

Furthermore, the vehicle 10 comprises a control system 20 which will be presented further hereinbelow. Additionally, the vehicle 10 may comprise a wind sensor 22 adapted to detect wind information. Instead of, or in addition to the wind sensor 22, the vehicle may comprise a communication assembly 24 adapted to at least receive wind information indicative of the wind condition around the vehicle 10.

Irrespective of how the wind information is determined, as a non-limiting example, the wind information may be indicative of a wind speed, relative to the vehicle 10, of a wind currently acting on the vehicle 10. As another non-limiting example, the wind information may be indicative of a wind heading, relative to the vehicle 10, of a wind currently acting on the vehicle 10.

As such, it should be noted that the wind speed, relative to the vehicle entity 10, may be referred to as a “apparent wind” being the wind experienced by the vehicle 10 motion. As such, the apparent wind may be regarded as the sum of the wind speed a moving object would experience in still air plus the velocity of the true wind. As such, the apparent wind may be used for determining each of the wind speed, relative to the vehicle 10, as well as the wind heading, relative to the vehicle 10, of a wind currently acting on the vehicle.

A wind sensor 22 may automatically measure the “apparent wind”, viz the sum of the wind speed a moving object would experience in still air plus the velocity of the true wind, and may thus present information of the wind speed and/or heading relative to the vehicle 10. A communication assembly 24 may for instance present information indicative of the characteristics of the true wind, in terms of speed and/or heading, and the communication assembly 24, or another entity of the vehicle 10, may thereafter determine the “apparent wind” on the basis of the true wind and the current operating characteristics, e.g. the current speed and direction, of the vehicle 10.

As may be realized from the above, the wind information may be determined in a plurality of different ways.

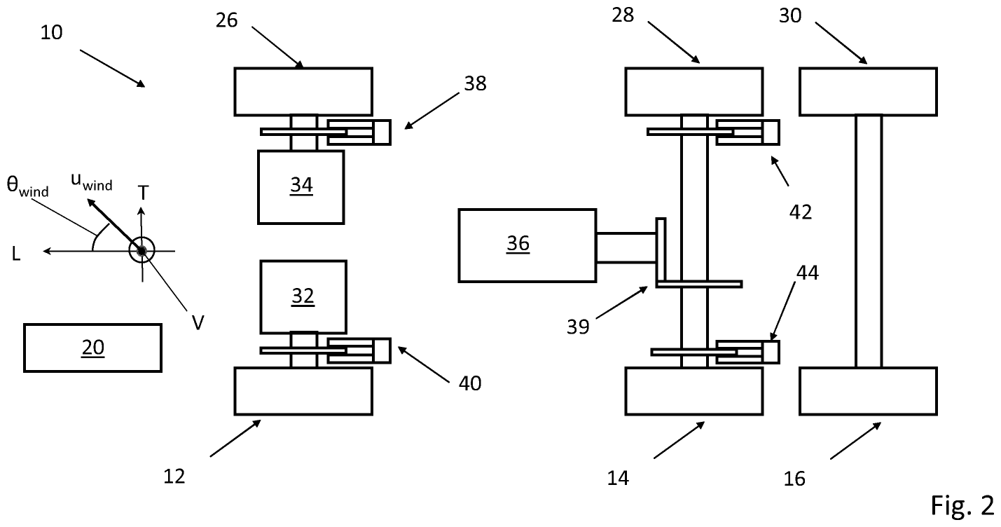

FIG. 2 is a schematic top view of a portion of a vehicle 10, such as the FIG. 1 vehicle 10. As may be gleaned from FIG. 2, the vehicle 10 may comprise a plurality of ground engaging members 12, 14, 16, 26, 28, 30, each one of which being exemplified as a wheel in FIG. 2.

Moreover, FIG. 2 illustrates that the vehicle 10 may comprise one or more motion support devices 32, 34, 36, 38, 40, 42, 44 for creating a resulting force vector on the vehicle 10.

Purely by way of example, as indicated in FIG. 2, at least a first motion support device 32 comprises an electric machine. Preferably, and as exemplified in FIG. 2, each one of a plurality of motion support devices 32, 34, 36 comprises an electric machine. A motion support device may comprise an electric machine that is connected to a single wheel, see e.g. each one of the leftmost electric machine containing motion support devices 32, 34 in FIG. 2. Alternatively, a motion support device may comprise an electric machine that is connected to a two or more wheels, see e.g. each one of the rightmost electric machine containing motion support device 36 in FIG. 2. Purely by way of example, and as indicated in FIG. 2, an electric machine may be connected to two wheels 14, 28 via a final gearing 39.

Moreover, though again purely by way of example, at least a second motion support device may comprise a service brake. Preferably, and as exemplified in FIG. 2, each one of a plurality of motion support devices 38, 40, 42, 44 comprises a service brake. In the FIG. 2 embodiment, each one of the service brakes is exemplified as a disc brake, but it is of course envisaged that other implementations of a service brake may be used, such as a drum brake (not shown).

FIG. 2 illustrates that the vehicle 10 comprises the control system 20 that has been mentioned above. The control system 20 is adapted to communicate with each one of the motion support devices 32, 34, 36, 38, 40, 42, 44 as well be presented hereinbelow.

Moreover, FIG. 2 illustrates the speed u_{wind} and the heading θ_{wind} of wind acting on the vehicle 10. As may be realised from FIG. 2, the heading θ_{wind} may relate to the angle that the propagating direction of the wind forms with an axle extending in a direction parallel to the longitudinal direction L. As such, a heading θ_{wind} of 0° may indicate that the propagating direction of the wind is parallel to the longitudinal direction L. Moreover, a heading θ_{wind} of 90° may indicate that the propagating direction of the wind is parallel to the transversal direction T.

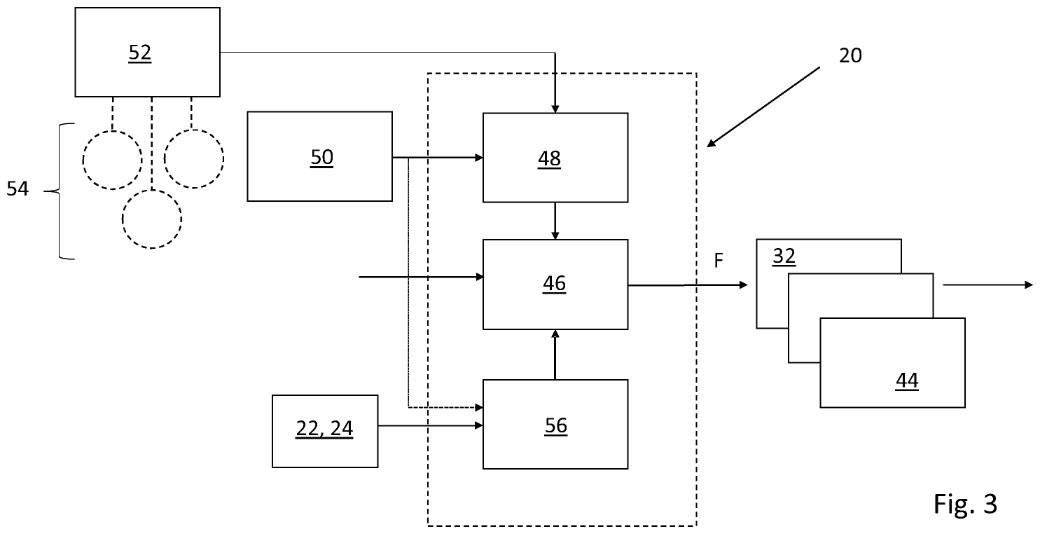

FIG. 3 is a schematic illustration of a control system 20 according to the present invention.

The control system 20 comprises a force determination controller 46 adapted to determine external load characteristics of external loads that currently act or are predicted to act on the vehicle 10. To this end, the force determination controller 46 may be adapted to receive information indicative of a current or predicted slope of the ground 18 (see FIG. 1) supporting the vehicle 10.

Moreover, the control system 20 is adapted to determine a resulting force vector F to be acting on the vehicle 10, using the external load characteristics, in order to obtain a requested vehicle operation behaviour. To this end, the control system 20 may comprise a vehicle operation behaviour portion 48 adapted to receive information indicative of a requested vehicle operation behaviour.

In this respect, though purely by way of example, the vehicle 10 may comprise an operation request controller 50 adapted to issue the operation request information to the control system. As a non-limiting example, such an operation request controller 50 may be adapted to issue the operation request information to the control system in response to input received from an operator of the vehicle 10. Thus, the operation request controller 50 may for instance comprise one or more of the following: an acceleration pedal (not shown), a brake pedal (not shown) and a steering wheel (not shown). However, it is also contemplated that the operation request controller 50 may form part of, or may be connected to, an autonomous drive system (not shown) that controls the operation of the vehicle 10.

By means of example, the operation request information may comprise information indicative of at least one of the following:
a requested acceleration of the vehicle 10;
a requested speed of the vehicle 10;
a requested rate of acceleration of the vehicle 10 (i.e. information relating to jerk), and
a requested total force acting on the vehicle 10.

Moreover, though purely by way of example, the vehicle operation behaviour portion 48 may also be adapted to receive information from a vehicle state determination portion 52. Purely by way of example, and as indicated in FIG. 3, the vehicle state determination portion 52 may be adapted to receive information from a set of sensors associated with the vehicle 10. Purely by way of example, the set of sensors may include one or more of the following sensor types: a radar, a lidar, a vision sensor (such as a camera), a global position sensor and a wheel sensor adapted to detect the rotational speed of a wheel of the vehicle 10.

On the basis of the information received from the set of sensors, the vehicle state determination portion 52 may be adapted to determine a current state of the vehicle 10. Purely by way of example, the current state may be indicative of one or more of the following: a current speed, a current direction and a current acceleration of the vehicle.

The information indicative of the current state of the vehicle 10 may be forwarded to the vehicle operation behaviour portion 48. Moreover, the vehicle operation behaviour portion 48 may be adapted to use the information indicative of the current state of the vehicle 10 and the operation request information in order to determine information indicative of a requested change of the state of the vehicle 10. The information of the information indicative of the requested change of the state of the vehicle 10, such as speed change in order to arrive at a requested speed, may be forwarded to the force determination controller 46.

It should be noted that the above embodiment with the vehicle operation behaviour portion 48, operation request controller 50 and the vehicle state determination portion 52 should be seen as one of many possible embodiments of the control system 20.

However, as a non-limiting example, irrespective of the configuration the control system 20, the control system 20 may be adapted to determine the resulting force vector F using the external load characteristics and the above-mentioned operation request information.

Furthermore, as indicated in FIG. 3, the control system 20 is further adapted to issue control information to one or more motion support devices 32, 34, 36, 38, 40, 42, 44 of the vehicle 10 in order to control the one or more motion support devices 32, 34, 36, 38, 40, 42, 44 so as to generate the resulting force vector F on the vehicle 10.

The above control information may be issued in a plurality of different ways. Purely by way of example, the control information may comprise an individual information portion that is issued individually to each one of the one or more motion support devices 32, 34, 36, 38, 40, 42, 44. As another non-limiting alternative, the control information may comprise information indicative of how each one of a plurality of the motion support devices 32, 34, 36, 38, 40, 42, 44 should be controlled. In such an implementation, the control information may comprise information tags or the like such that each motion support devices 32, 34, 36, 38, 40, 42, 44 can detect what information portion of the control information that is applicable to each specific motion support device 32, 34, 36, 38, 40, 42, 44.

Moreover, as indicated in FIG. 3, the control system 20 comprises a feedforward controller 56 adapted to receive wind information representative of a wind currently acting or predicted to be acting on the vehicle 10. Purely by way of example, and as indicated in FIG. 3, in embodiments of the control system 20, the feedforward controller 56 may be adapted to receive information from one or both of the above-mentioned wind sensor 22 and the communication assembly 24.

Further, again as schematically illustrated in FIG. 3, the feedforward controller 56 is in communication with the force determination controller 46 whereby the force determination controller is adapted to use wind load information, indicative of the wind load imparted on the vehicle 10 and determined on the basis of the wind information, for determining at least a portion of the external load characteristics.

As a non-limiting example, the control system 20 may be adapted to use at least the following entities for determining the wind load information:
the wind information;
a drag coefficient C_{d}, a side force coefficient Cₛ, and/or a lift coefficient Cₗ associated with the vehicle 10, and
a reference area A associated with the vehicle.

The drag coefficient C_{d} may be used for calculating a wind drag load, i.e. a wind load acting in the longitudinal direction L (see FIG. 1). The side force coefficient Cₛ may be used for calculating a wind side force load, i.e. a wind load acting in the transversal direction T (see FIG. 1). Further, the lift coefficient Cₗ may be used for calculating a lift load, i.e. a wind load acting in the vertical direction V (see FIG. 1).

It should be noted that each one of the drag coefficient C_{d}, the side force coefficient Cₛ, and the lift coefficient Cₗ associated with the vehicle 10, and possibly also the reference area A associated with the vehicle 10, may be dependent on the heading θ_{wind} of the wind. As such, using the drag coefficient C_{d} as an example, the magnitude of a wind load F_{L}w acting on the vehicle 10 in the longitudinal direction L may be determined in accordance with the following:

$${F}_{LW} = \frac{1}{2} ρ {u}_{wind}^{2} {C}_{d} ( {θ}_{wind} ) A ( {θ}_{wind} ) \qquad ( Eq . 1 )$$

wherein:
ρ is the density of air;
u_{wind} is the wind speed relative to the vehicle 10;
C_{d}(θ_{wind}) is the drag coefficient, and
A(θ_{wind}) is the reference area.

As may be realized from the above, the value of the drag coefficient C_{d} may be dependent on the heading θ_{wind} of the wind acting on the vehicle 10. As such, though purely by way of example, the absolute value of the drag coefficient C_{d} may be relatively large for headings θ_{wind} being approximately 0° or 180° since such headings indicate winds propagating in a direction substantially parallel to the longitudinal direction L. As another non-limiting example, the absolute value of the drag coefficient C_{d} may be relatively small for headings θ_{wind} being approximately 90° or 270° since such headings indicate winds propagating in a direction substantially perpendicular to the longitudinal direction L.

The above examples and heading dependencies apply mutatis mutandis to each one of the following example equations for determining the magnitude of a wind load F_{TW} acting on the vehicle 10 in the transversal direction T as well as a wind load F_{VW} acting on the vehicle 10 in the transversal direction V:

$${F}_{TW} = \frac{1}{2} ρ {u}_{wind}^{2} {C}_{s} ( {θ}_{wind} ) A ( {θ}_{wind} ) \qquad ( Eq . 2 )$$

$${F}_{VW} = \frac{1}{2} ρ {u}_{wind}^{2} {C}_{l} ( {θ}_{wind} ) A ( {θ}_{wind} ) \qquad ( Eq . 3 )$$

Purely by way of example, the absolute value of the lift coefficient Cₛ may be relatively large for headings θ_{wind} being approximately 90° or 270° since such headings indicate winds propagating in a direction substantially parallel to the transversal direction T. As another non-limiting example, the absolute value of the lift coefficient Cₗ may be relatively small for headings θ_{wind} being approximately 0° or 180° since such headings indicate winds propagating in a direction substantially parallel to the longitudinal direction L.

Moreover, it should be noted that, in embodiments of the control system 20, the reference area A need not be dependent on the heading θ_{wind}. Instead, a fixed reference area A may be used for every heading and the actual area dependence of the heading θ_{wind} may instead be included in the drag coefficient C_{d}, the side force coefficient Cₛ, and the lift coefficient Cₗ.

Irrespective of how the drag coefficient C_{d}, the side force coefficient Cₛ, and the lift coefficient Cₗ and the reference area A are used, the control system 20 may preferably be adapted to use data indicative of relevant information for a plurality of different headings θ_{wind}. Then, once an actual heading θ_{wind} of the wind has been determined, relevant values of the relevant coefficients C_{d}, Cₛ, Cₗ, and possibly also the reference area A, may be established using e.g. the above data and an interpolation operation.

Purely by way of example, the control system 20 may store information relating to the drag coefficient C_{d}, the side force coefficient Cₛ, and the lift coefficient Cₗ and the reference area A. However, it is also envisaged that the control system 20 may be adapted to receive such data from sources outside the control system 20 or even outside the vehicle 10, for instance using wireless communication means.

Irrespective of how the control system 20 can access the above data, the data can be used for determining wind load information, indicative of the wind load imparted on the vehicle 10.

As a non-limiting example, the feedforward controller 56 may be adapted to determine the wind load information. Thus, using FIG. 3 as an example, the feedforward controller 56 may be adapted to receive wind information representative of a wind currently acting or predicted to be acting on the vehicle 10. As has been intimated hereinabove, the wind information may be indicative of a wind speed u_{wind}, relative to the vehicle 10 and of a wind heading θ_{wind}, relative to the vehicle 10, of a wind currently acting on the vehicle 10.

Using the above wind information and e.g. data relating to the drag coefficient C_{d}, the side force coefficient Cₛ, the lift coefficient Cₗ and the reference area A, be such data stored by in the feedforward controller 56, another portion of the control system 20 or an entity outside the control system 20, the feedforward controller 56 may determine one or more wind load components F_{L}w, F_{TW}, F_{VW}, for instance using one or more of Eq. 1-Eq. 3 hereinabove. As such, the wind load information may comprise information relating to the magnitude and preferably also the direction of the wind load acting on the vehicle 10.

Although the above presentation is based on embodiments in which the feedforward controller 56 determines the wind load information, it is also contemplated that in other embodiments of the control system 20, the feedforward controller 56 may only issue the wind information to the force determination controller 46 and that the force determination controller 46 instead determines the wind load information, for instance using Eq. 1-Eq. 3 hereinabove.

In the FIG. 3 embodiment of the control system 20, the wind load information is fed to the force determination controller 46. Moreover, the FIG. 3 force determination controller 46 may be adapted to receive information from the vehicle operation behaviour portion 48 adapted to receive information indicative of a requested vehicle operation behaviour. The information issued from the vehicle operation behaviour portion 48 may be indicative of a load required in order to obtain a certain vehicle operation behaviour without taking any outside loads into account. As another example, the information issued from the vehicle operation behaviour portion 48 may be indicative of a certain motion behaviour, such as a certain acceleration, and the force determination controller 46 may be adapted to determine a load required in order to arrive at such a motion behaviour.

As may be gleaned from the above, loads may be determined in various portions of the control system 20 but the force determination controller 46 may preferably be able to determine a resulting force vector F to be acting on the vehicle 10, using the external load characteristics, in order to obtain a requested vehicle operation behaviour.

The above functionality will be explained hereinbelow with an example that is limited to movements and loads in the longitudinal direction L. However, it should be noted that the above example can be easily expanded into examples with movements and/or loads in at least two directions, such as the longitudinal direction L as well as the transversal direction T, or even all three directions L, T and V.

As an example, the requested vehicle operation behaviour may be indicative of a certain longitudinal acceleration a_{L} of a vehicle 10 having a certain mass m. As such, without taking any ambient environmental loads into account, the longitudinal force F_{L}v needed in order to arrive at such a longitudinal acceleration a_{L} can be formulated as:

$${F}_{LV} = {a}_{L} \cdot m \qquad ( Eq . 4 )$$

However, if the vehicle 10 is travelling on a road with a non-zero slope, a certain longitudinal force Fₛₗₒₚₑ will act on the vehicle 10 resulting from the fact that that the vehicle 10 is travelling on the slope. Moreover, as has been intimated above, the vehicle 10 may be imparted a wind load with a longitudinal component F_{L}W. As such, in order to obtain the requested vehicle operation behaviour, viz the longitudinal acceleration a_{L} in the above example, the following resulting force F_{Lres} will be needed:

$${F}_{Lres} = {F}_{LV} + {F}_{slope} + {F}_{LW} \qquad ( Eq . 5 )$$

As such, the control system 20 may be adapted to issue control information to the one or more motion support devices 32, 34, 36, 38, 40, 42, 44 of the vehicle 10 in order to control the motion support devices so as to generate a resulting force vector on the vehicle 10, which force vector results in the resulting force F_{Lres} as indicated above in the longitudinal direction L.

It should again be noted that in the above example, in order to simplify the explanation of the determination of the resulting force vector F, the resulting force vector is only determined in the longitudinal direction such that F=F_{L}. However, in embodiments of the present invention, the force vector F may comprise a plurality of components. As such, a force vector may be determined in accordance with the following.

$$F = ( {F}_{L} , {F}_{T} , {F}_{V} , {M}_{L} , {M}_{T} , {M}_{V} ) \qquad ( Eq . 6 )$$

wherein:
F_{L} is a force component in the longitudinal direction L;
F_{T} is a force component in the transversal direction T;
F_{V} is a force component in the vertical direction V;
M_{L} is a moment around an axis extending in the longitudinal direction L, which moment may also be referred to as a roll moment;
M_{T} is a moment around an axis extending in the transversal direction T, which moment may also be referred to as a pitch moment, and
M_{V} is a moment around an axis extending in the vertical direction V, which moment may also be referred to as a yaw moment.

It is of course also contemplated that embodiments of the invention may use any possible subset of the six components listed hereinabove. Generally, each one of the moments M_{L}, M_{T} and M_{V} can be determined using an equation similar to one of the equations presented in Eq. 1-Eq. 3 hereinabove, although a corresponding equation for the moment also contains a term relating to the distance from a centre of the wind load to the relevant axis.

Moreover, it is also envisaged that in embodiments of the invention, the wind load information and consequently also the external load characteristics, may have two or more of the components presented in Eq. 6 hereinabove. As such, a wind load vector may be determined in accordance with the following: F_{W}=(F_{LW}, F_{TW}, F_{VW}, M_{LW}, M_{TW}, M_{VW}) whereas in other embodiments, the wind load vector may comprise a subset of the six components listed hereinabove.

As such, though purely by way of example, the control system 20 may be adapted to issue control information to one or more motion support devices 32, 34, 36, 38, 40, 42, 44 of the vehicle 10 in order to control the one or more motion support devices 32, 34, 36, 38, 40, 42, 44 so as to generate a resulting force vector:

F=(F_{L},F_{T},F_{V},M_{L},M_{T},M_{V})

on the vehicle 10.

As such, though purely by way of example, the force determination controller 46 may be adapted to use wind load information that comprises a wind load vector F_{W}=(F_{LW}, F_{TW}, F_{VW}, M_{LW}, M_{TW}, M_{VW}) as has been intimated hereinabove. Moreover, the control system 20 may be adapted to determine a resulting force vector F=(F_{L}, F_{T}, F_{V}, M_{L}, M_{T}, M_{V} to be acting on the vehicle 10, using the external load characteristics in the six degrees of freedom as has been indicated above, in order to obtain a requested vehicle operation behaviour.

As such, though purely by way of example, should the force determination controller 46 identify a large transversal wind load and/or a large wind induced roll moment—which for instance may occur when a vehicle 10 is passing a bridge—the control system 20 may be adapted to determine a resulting force vector F=(F_{L}, F_{T}, F_{V}, M_{L}, M_{T}, M_{V}) with a relatively large transversal load F_{T} counteracting the transversal wind load and/or a relatively large righting roll moment M_{L}. The control system may thereafter be adapted to issue control information to the one or more motion support devices 32, 34, 36, 38, 40, 42, 44 of the vehicle 10 in order to control the one or more motion support devices 32, 34, 36, 38, 40, 42, 44 so as to generate such a resulting force vector F.

Purely by way of example, in order to determine how the motion support devices (32, 34, 36, 38, 40, 42, 44) should be operated in order to provide the above mentioned force vector F=(F_{L}, F_{T}, F_{V}, M_{L}, M_{T}, M_{V}), the following equation may be used:

$$[ \begin{matrix}{F}_{L} \\ {F}_{T} \\ {F}_{V} , \\ {M}_{L} \\ {M}_{T} \\ {M}_{V}\end{matrix} ] = [ \begin{matrix}{b}_{11} & ⋯ & {b}_{1 m} \\ ⋮ & ⋱ & ⋮ \\ {b}_{61} & ⋯ & {b}_{6 m}\end{matrix} ] [ \begin{matrix}{u}_{1} \\ ⋮ \\ {u}_{m}\end{matrix} ] \qquad ( Eq . 7 )$$

wherein
uₖ is a parameter indicative of a state of the vehicle 10, and
bⱼₖ is a connection parameter indicative of the relation between the j:th degree of freedom of the force vector and the k:th state of the vehicle 10.

Using Eq. 7 hereinabove, for a target F=(F_{L}, F_{T}, F_{V}, M_{L}, M_{T}, M_{V}), it is possible to determine the values for each one of the parameters uₖ indicative of the state of the vehicle 10 which result in the target force vector F. Purely by way of example, at least a subset of the parameters indicative of the state of the vehicle may be such that each parameter in the subset relates to, or even corresponds to, the torque produced one of the motion support devices (32, 34, 36, 38, 40, 42, 44). However, other parameters of the set of parameter indicative of a state of the vehicle may be indicative of a steering angle or the like. Although Eq. 7 above is exemplified for determining a force vector F with six degrees of freedom, it is also envisaged that in embodiments of the invention Eq. 7 may be used for determining a force vector with less degrees of freedom, e.g. F=(F_{L}, F_{T}, M).

Moreover, it should be noted that although each one of the wind loads F_{L}w, F_{TW}, F_{VW} are exemplified as being determined using the relative wind speed and heading, see e.g. each one of Eq. 1-Eq. 3 hereinabove, it is also possible to split the loads into a first wind load portion related to the movement of the vehicle 10 at zero wind speed and a second wind load portion related to the speed of the wind. As such, using the wind load F_{LW} in the longitudinal direction as an example, the wind load may be determined in accordance with the following:

$${F}_{LW} = {F}_{LWv} + {F}_{LWa} \qquad ( Eq . 7 )$$

wherein:
F_{LWv} is the longitudinal drag load acting on the vehicle 10 due to the speed of the vehicle only, and F_{LWa} is the longitudinal drag load acting on the vehicle 10 due to the speed of the wind.

The above split may of course be performed for the wind loads F_{TW}, F_{VW} in the other directions T, V as well.

It should be noted that in embodiments of the control system 20, the control system 20 may be adapted to use the operation request information and the wind information in order to determine a predicted future wind information.

Purely by way of example, the control system 20 may adapted to use the operation request information for determining at least a predicted future speed of the vehicle 10. For instance, the operation request information may be indicative of an intended speed of the vehicle 10. As another non-limiting example, the operation request information may be indicative of an intended, e.g. ongoing or future, acceleration of the vehicle 10 and it may be possible to determine a future speed profile on the basis of the intended acceleration.

As such, though purely by way of example, the control system 20 may be adapted to use the predicted future speed of the vehicle 10, the wind speed (u_{wind}) and the wind heading (θ_{wind}) for determining a predicted future wind speed (u_{wind}′) and a predicted future wind heading (θ_{wind}′).

To this end, though purely by way of example, if the information from the operation request controller 50 is indicative of a certain speed and/or a requested speed change of the vehicle 10, such information may be used for modifying the wind information, e.g. the wind speed u_{wind} relative to the vehicle 10. Thus, a future predicted relative wind speed u_{wind}′ may be used when determining the wind load information and this may in turn result in that the requested vehicle operation behaviour may be arrived at within an appropriately short time range. The above possibility is indicated by a dotted line extending from the operation request controller 50 to the feedforward controller 56 in FIG. 3. However, it should be noted that in other embodiments of the present invention, the predicted future wind information may be determined in other portions of the control system 20.

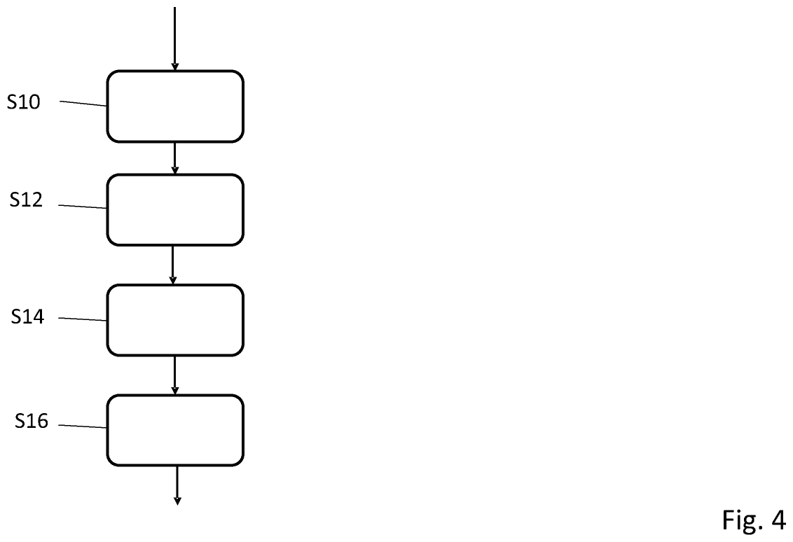

It should be noted that the above exemplifying embodiments of the control system 20 and/or the vehicle 10 are also intended to be used as examples for presenting the method of the present invention. However, for the sake of completeness, FIG. 4 is a flow chart schematically illustrating an embodiment of a method in accordance with the present invention.

As such, FIG. 4 is a flowchart illustrating a method for controlling a vehicle 10. The method comprises:
S10: determining external load characteristics of external loads that are currently imparted or predicted to be imparted on the vehicle 10,
S12: receiving wind information representative of a wind currently acting or predicted to be acting on the vehicle 10 and using wind load information, indicative of the wind load imparted on the vehicle and determined on the basis of the wind information, for determining at least a portion of the external load characteristics;
S14: determining a resulting force vector F to be imparted on the vehicle, using the external load characteristics, in order to obtain a requested vehicle operation behaviour, and
S16: issuing control information to one or more motion support devices of the vehicle 10 in order to control the one or more motion support devices 32, 34, 36, 38, 40, 42, 44 so as to impart the resulting force vector F on the vehicle 10.

It is to be understood that the present invention is not limited to the embodiments described above and illustrated in the drawings; rather, the skilled person will recognize that many changes and modifications may be made within the scope of the appended claims.

1. A control system for a vehicle:
the control system comprising a force determination controller adapted to determine external load characteristics of external loads that currently act or are predicted to act on the vehicle;
the control system being adapted to determine a resulting force vector to be acting on the vehicle, using the external load characteristics, in order to obtain a requested vehicle operation behaviour;
the control system further being adapted to issue control information to one or more motion support devices of the vehicle in order to control the one or more motion support devices so as to generate the resulting force vector on the vehicle;
wherein the control system comprises a feedforward controller adapted to receive wind information representative of a wind currently acting or predicted to be acting on the vehicle, the feedforward controller being in communication with the force determination controller whereby the force determination controller is adapted to use wind load information, indicative of the wind load imparted on the vehicle and determined on the basis of the wind information, for determining at least a portion of the external load characteristics.

2. The control system of claim 1, wherein the wind information is indicative of a wind speed, relative to the vehicle, of a wind currently acting on the vehicle.

3. The control system of claim 1, wherein the wind information is indicative of a wind heading, relative to the vehicle, of a wind currently acting on the vehicle.

4. The control system of claim 1, wherein the control system is adapted to use at least the following entities for determining the wind load information:
the wind information;
a drag coefficient, a side force coefficient, and/or a lift coefficient associated with the vehicle; and
a reference area associated with the vehicle.

5. The control system of claim 1, wherein the feedforward controller is adapted to determine the wind load information.

6. The control system of claim 1, wherein the wind load information comprises information relating to the magnitude and preferably also the direction of the wind load acting on the vehicle.

7. The control system of claim 1, wherein the control system is adapted to receive operation request information indicative of the requested vehicle operation behaviour.

8. The control system of claim 7, wherein the control system is adapted to determine the resulting force vector using the external load characteristics and the operation request information.

9. The control system of claim 7, wherein the operation request information comprises information indicative of at least one of the following:
a requested acceleration of the vehicle;
a requested speed of the vehicle;
a requested rate of acceleration of the vehicle; and
a requested total force acting on the vehicle.

10. The control system of claim 1, wherein the resulting force vector comprises a component extending in the intended direction of travel of the vehicle.

11. The control system of claim 7, wherein the control system is adapted to use the operation request information and the wind information in order to determine a predicted future wind information.

12. The control system of claim 11, wherein:
the wind information is indicative of a wind speed, relative to the vehicle, of a wind currently acting on the vehicle;
the wind information is indicative of a wind heading, relative to the vehicle, of a wind currently acting on the vehicle; and
the control system is adapted to use the operation request information for determining at least a predicted future speed of the vehicle, the control system being adapted to use the predicted future speed of the vehicle, the wind speed and the wind heading for determining a predicted future wind speed and a predicted future wind heading.

13. A vehicle comprising one or more motion support devices for creating the resulting force vector on the vehicle, the vehicle further comprising the control system of claim 1.

14. The vehicle of claim 12, wherein at least a first motion support device comprises an electric machine, and wherein preferably each one of a plurality of motion support devices comprises an electric machine.

15. The vehicle of claim 13, wherein at least a second motion support device comprises a service brake, and wherein preferably each one of a plurality of motion support devices comprises a service brake.

16. The vehicle of claim 13, wherein the vehicle comprises an operation request controller adapted to issue the operation request information to the control system, and wherein preferably the operation request controller is adapted to issue the operation request information to the control system in response to input received from an operator of the vehicle.

17. A method for controlling a vehicle wherein the method comprises:
determining external load characteristics of external loads that are currently imparted or predicted to be imparted on the vehicle;
receiving wind information representative of a wind currently acting or predicted to be acting on the vehicle and using wind load information, indicative of the wind load imparted on the vehicle and determined on the basis of the wind information, for determining at least a portion of the external load characteristics;
determining a resulting force vector to be imparted on the vehicle, using the external load characteristics, in order to obtain a requested vehicle operation behaviour; and
issuing control information to one or more motion support devices of the vehicle in order to control the one or more motion support devices so as to impart the resulting force vector on the vehicle.
